(19) United States
(12) Patent Application Publication
(10) Pub. No.: US 2003/0014557 A1
(43) Pub. Date: Jan. 16, 2003

(54) System and method for transforming operating system audit data to a desired format

(76) Inventors: Joubert Berger, Atlanta, GA (US); Scott Alan Leerssen, Atlanta, GA (US)

Correspondence Address: HEWLETT-PACKARD COMPANY, Intellectual Property Administration, P. O. Box 272400, Fort Collins, CO, 80527-2400, US

(21) Appl. No.: 09/896,351

(22) Filed: Jun. 29, 2001

(51) Int. Cl. G06F 9/46

(52) U.S. Cl. 709/318; 717/128

(57) ABSTRACT

A system and method are disclosed which enable generation of output that includes collected audit data formatted in a desired manner. Such collected audit data relates to the execution of a routine. In one embodiment, a processor-based system is disclosed that comprises an operating system that includes at least one routine capable of being invoked. The operating system may also operable to collect audit data for invoked operating system routines. The system further comprises software code executable to receive collected audit data and generate output that includes at least a portion of the collected audit data in a desired format that is defined by a template. A library of functions is also disclosed that enable accessing collected audit data, accessing a template, and generating output formatted according to the template.

### RELATED APPLICATIONS

This application is related to concurrently filed and commonly assigned U.S. patent application Ser. No. ______ entitled “SYSTEM AND METHOD FOR AUDITING SYSTEM CALL EVENTS WITH SYSTEM CALL WRAPPERS,” the disclosure of which is hereby incorporated herein by reference.

### TECHNICAL FIELD

The present invention relates in general to auditing within a computer operating system, and more specifically to a system and method in which operating system audit data is transformed to a desired format.

### BACKGROUND

An Operating System (OS) is arguably the most important program executing on a computer system, because the OS is utilized in executing all other programs (which are commonly referred to as “applications”). In general, the OS provides functionality that applications may then utilize. For instance, an application may invoke an OS routine (e.g., via a system call) to save a particular file, and the OS may interact with the basic input/output system (BIOS), dynamic link libraries, drivers, and/or other components of the computer system to properly save the particular file. Many different OSs have been developed in the prior art, including HP-UX®, Linux™, MS-DOS®, OS/2®, Windows®, Unix™, System 8, and MPE/iX, as examples.

FIG. 1 shows an exemplary system 100, which includes an OS 101. As shown, OS 101 may perform such tasks as recognizing input from keyboard 106 and mouse 104, sending output to display screen 107, and controlling peripheral devices, such as disk drive 103 and printer 105. Some OSs have integrated therein relatively complex functions that were once performed only by separate programs, such as faxing, word processing, disk compression, and Internet browsers. Generally, OSs provide a software platform on top of which other programs, such as application 102, can execute. Application programs are generally written to execute on top of a particular OS, and therefore, the particular OS implemented on a computer system may dictate, to a large extent, the types of applications that can be executed on such computer system.

Application 102 executing on computer system 100 may rely on operating system routines to perform such basic tasks as recognizing input from keyboard 106 and mouse 104, as well as sending output to display screen 107, as examples. OS 101 comprises sets of routines for performing various tasks (e.g., low-level operations). For example, operating systems commonly include routines for performing such tasks as creating a directory, opening a file, closing a file, and saving a file, as examples. Application 102 may invoke certain operating system routines to perform desired tasks by making a system call. That is, applications generally invoke operating system routines via system calls. Also, a user may interact with OS 101 through a set of commands. For example, the DOS operating system contains commands such as COPY and RENAME for copying files and changing the names of files, respectively. The commands are accepted and executed by a part of the OS called the command processor or command line interpreter. Additionally, a graphical user interface may be provided to enable a user to enter commands by pointing and clicking objects appearing on the display screen, for example.

OSs may have many responsibilities in addition to those described above. For example, OSs may also have responsibility for ensuring that different applications and users running at the same time do not interfere with each other. OSs may further have responsibility for security, e.g., ensuring that unauthorized users do not access the system (or at least forbidden portions of the system). For instance, “trusted” (secure) OSs that include security mechanisms therein have been developed in the prior art, such as those that have been designed for handling and processing classified governmental (e.g., military) information. Additionally, OSs commonly audit operating system routines (which may be referred to as “events”) utilized by applications and/or users. For instance, OSs commonly collect audit data regarding use of an operating system routine that is invoked via a system call (or “syscall”) made by an application. For example, suppose an application makes a system call to open a particular file, an audit program within the operating system may collect such audit data for the system call as the date and time the system call was made, name of file to be opened, and result of system call (e.g., system file opened successfully or failed). Such auditing may be performed as part of the security mechanisms included within the OS, for example. In particular, trusted OSs, including without limitation Hewlett-Packard CMW (compartment mode workstation), Hewlett-Packard VirtualVault, Sun Trusted Solaris, and SCO CMW, commonly perform auditing of at least security relevant events.

As is well known to those of ordinary skill in the art, the central module of an OS is the kernel. Generally, it is the part of the OS that loads first, and it typically remains in main memory. Typically, the kernel is responsible for such tasks as memory management, process and task management, and disk management, as examples. The kernel of an OS that provides auditing is typically responsible for performing such auditing, as well. Once audit data is collected in the kernel, an audit collection daemon (or process) typically collects the audit data from the kernel and writes it to disk. Such audit collection daemon may execute outside the kernel (e.g., within the user-space of the OS). Thereafter, a user, such as a system administrator, may view the collected audit data to, for example, trouble-shoot a problem being encountered with the computer system or evaluate the system's security.

However, collected audit data is generally presented in a fixed, inflexible format in prior art systems. The inflexibility of audit data format in prior art systems is problematic for several reasons. First, a lot of information may be collected for a particular event, which may result in difficulty parsing through such information when displayed to a user. Thus, a system administrator may effectively have an “information overload” (or a lot of “noise” in the audit trail) as too much information is presented for an event, which may increase the difficulty in evaluating the audit data (e.g., for determining the root cause of a problem within the system or evaluating the system's security). Thus, more information than is desired by a user (e.g., system administrator) may be presented when displaying collected audit data. Additionally, the collected audit data is typically presented in a fixed, inflexible format. Thus, not only may a user be required to evaluate a large amount of audit data, but such audit data may be presented in an undesirable format. More specifically, the provider of the particular OS that includes the auditing functionality typically provides a display application for displaying the collected audit data, and such display application generally dictates the specific format in which the collected audit data is to be presented. However, a user may desire for the audit data to be presented in a different format (e.g., in a particular format that would ease system trouble-shooting or evaluation of system security), but the user is required to adapt to the inflexible format of the display application.

### SUMMARY OF THE INVENTION

According to at least one embodiment of the present invention, a system is disclosed that comprises an operating system providing at least one routine capable of being invoked. Further, such operating system is operable to collect audit data for invoked operating system routines. The system further comprises data storage having the collected audit data stored thereto in a first format. Additionally, software code is included that is executable by at least one processor to receive collected audit data and generate output comprising at least a portion of such collected audit data in a desired format defined by a template, wherein the desired format is different than the first format in which the collected audit data is stored in data storage.

According to at least one embodiment of the present invention, a computer program product is disclosed that is executable to generate audit data that relates to execution of a routine in a desired format as defined by a template, which may be referred to as an audit transformation template. More specifically, the computer program product includes code executable to access audit data stored in a data storage device, wherein such audit data comprises information relating to execution of at least one invoked routine. The computer program product further includes code executable to access an audit transformation template, and code executable to generate output comprising at least a portion of the collected audit data, wherein the generated output has a format as defined by the audit transformation template.

At least one embodiment of the present invention provides a method of generating an output that includes collected audit data therein arranged in a desired format, wherein such format is dictated by a template. For example, according to one embodiment, audit data relating to the execution of one or more invoked routines is collected, and such audit data is stored to a data storage device. The method further comprises accessing the collected audit data, and accessing an audit transformation template that defines a desired format. An output is generated that includes at least a portion of the collected audit data, wherein the output is arranged in a desired format as defined by the audit transformation template.

Additionally, according to at least one embodiment of the present invention, a library of software functions (e.g., an API library) is disclosed, which includes functions that enable an application to access collected audit data, access a template that defines a desired output format, and generate an output that includes audit data therein and has a format according to the template. For instance, in one embodiment, the library includes a function that is executable to access collected audit data that comprises information about at least one invoked routine. The library further includes a function executable to access a template defining an output format. The library further includes a function executable to generate output comprising at least a portion of the collected audit data, wherein the output has a format as defined by the template.

### BRIEF DESCRIPTION OF THE DRAWINGS

FIG. 1 shows an exemplary prior art computing system, that includes an operating system;

FIG. 2 shows a typical configuration of prior art systems for generating OS audit data;

FIG. 3 shows an exemplary system of an embodiment of the present invention in which OS audit data may be formatted in a desired manner;

FIG. 4 shows an exemplary implementation of one embodiment of the present invention in which OS audit data is formatted according to template A;

FIG. 5 shows a further exemplary implementation of one embodiment of the present invention in which OS audit data is formatted according to template B; and

FIG. 6 shows still a further exemplary implementation of one embodiment of the present invention in which OS audit data is formatted according to template C.

### DETAILED DESCRIPTION

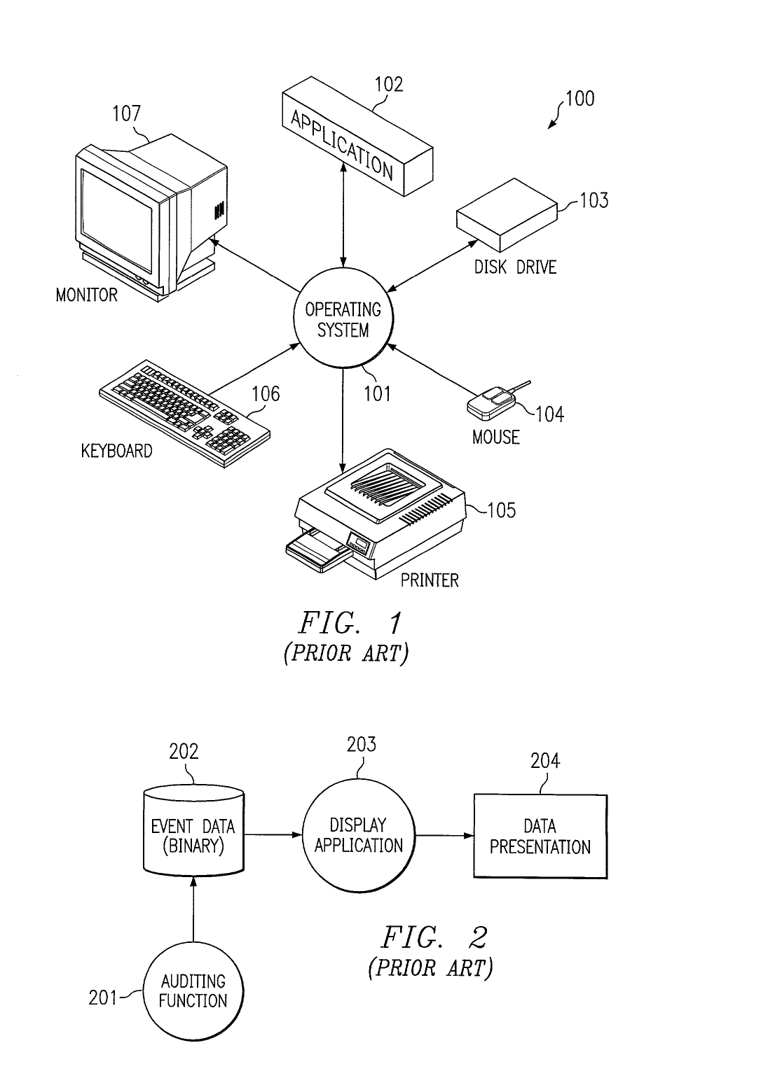

Various embodiments of the present invention are now described with reference to the attached figures, wherein like reference numerals represent like parts throughout the several views. Turning to FIG. 2, a typical configuration of prior art systems for generating OS audit data is shown. As shown, auditing program 201 is executing on a system, which is operable to audit (i.e., collect data relating to) the execution of routines (which may be referred to as “events”). Such routines may comprise operating system routines and/or application level routines. For instance, auditing program 201 may execute in the kernel of an OS to collect audit data regarding use of an operating system routine that is invoked via a system call (or “syscall”) made by an application. For example, as mentioned earlier, suppose an application makes a system call to open a particular file, audit program 201 within the OS may collect such audit data for the system call as the date and time the system call was made, name of file to be opened, and result of system call (e.g., system file opened successfully or failed). As a further example, such audit data may be collected for an operating system routine invoked via user command. Additionally, auditing program 201 may, in certain implementations, not be arranged within the kernel of an OS. Rather, auditing program 201 may, for example, be implemented as a subsystem that executes in the user space of an OS to audit routines of applications (e.g., to collect data relating to the execution of application-level routines).

In certain implementations, auditing program 201 may audit only security events, but in other implementations it may provide additional auditing (e.g., may include application and system level logging). According to at least one implementation, auditing program 201 may comprise an audit device driver that collects audit data. Additionally, auditing program 201 may comprise an interface (e.g., API) from the kernel to user-space applications, which may enable event data to be passed to such user-space applications (e.g., an audit collection daemon) and/or may enable event data to be received at the kernel from user-space applications and/or users (e.g., system administrators). Thus, according to at least one implementation, program 201 may collect kernel audit events and application audit events received from user-space applications, as well as any other types of audit events desired to be collected by the OS.

Auditing program 201 stores the audit data (which may be referred to as “event data”) to data storage 202. Data storage 202 generally comprises a disk drive. According to at least one implementation, collected audit data may be buffered within the kernel of the OS, and as such buffer begins filling, the kernel notifies an audit collection daemon, which is a process (that may be executing in the user space of the OS) that collects the audit data from the kernel and writes it to data storage 202. Typically, collected audit data is stored in binary format within data storage 202. Audit data collected for a particular event (e.g., particular invocation of an OS routine) is generally referred to as a record. Thus, data storage 202 may include many records, wherein each record includes audit data for a particular event.

Display application 203 is typically provided by the provider of the OS that includes auditing program 201. Display application 203 is typically a user-space application that is executable to retrieve collected audit data from data storage 202 and present the data to a user on a display 204 (e.g., computer monitor). A user, such as a system administrator, may view the collected audit data to, for example, trouble-shoot a problem being encountered with the computer system or evaluate the system's security. However, as described above, the presentation of audit data is generally in a fixed, inflexible format. That is, display application 203 generally presents the collected audit data available in data storage 202 according to a fixed, inflexible format.

While collected auditing information may be a valuable resource to system administrators and may provide a primary source of information for evaluating system performance/security and trouble-shooting problems occurring within the system, the utilization of auditing information has not been fully recognized in prior art systems because of the inflexible format in which such information is presented. As described above, the inflexibility of such audit data presentation is problematic for several reasons. For example, audit data for many events may be stored in data storage 202. That is, the audit data may comprise many records stored in data storage 202. Additionally, a considerable amount of information may be collected for each event. That is, each record may include a considerable amount of information, which may result in difficulty in a user parsing through such information when provided in presentation 204. Thus, more information than is desired by a user (e.g., system administrator) may be presented when displaying collected audit data.

Generally, display application 203 provides each record from data storage 202 in presentation 204, which may result in a very large amount of information being presented. For example, after auditing program 201 collects audit data for several hours, there may be many records (and gigabytes of audit data) stored within data storage 202 that is presented to a user by display application 203, which is an enormous amount of information for the user to interpret/evaluate. Such large amount of information included in presentation 204 often creates difficulty in evaluating the system performance to, for example, trouble-shoot a problem being encountered within the system or evaluate the system's security.

Some display applications 203 may allow a user to effectively filter certain events (or certain records) for which audit data has been collected. For instance, display application 203 may enable a user to specify that all records collected during a particular time frame are to be presented, wherein the records outside of the particular time frame are filtered by display application 203 and not included in data presentation 204. As another example, display application 203 may enable a user to specify that records for a particular type of event (e.g., file open event) are to be presented, wherein records for other types of events may be filtered and not included in data presentation 204. While display application 203 may allow a user to specify a filter of the records of audit data, display application 203 generally does not allow a user to filter information from the records. That is, display application 203 does not allow a user to specify that only a desired portion of the information included in a record is to be presented in presentation 204. For instance, suppose that auditing program 201 collects date, time, and file name, for a file open event and result of the event, and such information is stored as audit data within a record in data storage 202. Further suppose that a user desires to have a presentation of the collected audit data for file open events which includes only the file name and the result of the event. Display application 203 does not provide such flexibility, but would instead present all of the information included in an event record within data presentation 204.

Additionally, display application 203 typically presents the collected audit data in a fixed, inflexible format. Thus, not only may a user be required to evaluate a large amount of audit data, but such audit data may be presented in an undesirable format. For instance, continuing with the above example in which a record is stored in data storage 202 for a file open event, display application 203 may present such record organized as “Date Time Filename Result.” However, the user may desire to have the information arranged as “Result Filename Date Time.” As other examples, the user may desire to have the audit information arranged in a comma separated value (CSV) format (e.g., “Date, Time, Filename, Result”) or comma delimited format, in a markup language format, such as hypertext markup language (HTML) or extensible markup language (XML), as examples, or other suitable format for being processed by an application, such as a spreadsheet or web browser. For instance, a user may desire to have collected audit data formatted in a suitable manner for input to another application for processing, such as an application that is executable to evaluate the collected audit data and detect potential system performance/security problems. Display application 203 does not allow the user to alter the fixed format in which display application 203 provides the audit data in presentation 204. Thus, display application 203 and/or the arrangement of data in data storage 202, rather than a user (such as a system administrator) generally dictate the specific format in which the collected audit data is to be presented in presentation 204. Accordingly, a user is typically required to adapt to the inflexible format of presentation 204 as provided by display application 203.

However, according to various embodiments of the present invention, audit data relating to the execution of a routine may be arranged according to a desired format, which may be defined by a user (e.g., system administrator). Such audit data may be collected by the OS in certain embodiments, and in alternative embodiments the audit data may be collected by an application executing in user space. At least one embodiment provides a transform application that utilizes a template to format collected audit data. Such template may be a user-defined view (or model) for event formatting (and/or presentation). As described in greater detail below, in certain embodiments of the present invention a user is in complete control over how audit data is formatted by assigning drop points in a text-based file that effectively act as place holders specifying points at which corresponding audit data is to be arranged. In certain embodiments, the template file may be created and edited by a user, such as a system administrator, via any suitable text editing application, such as any text editor now known or later developed, including as examples vi and emacs. The resulting formatted audit data generated by the transform application may be presented to a user. Additionally (or alternatively), the resulting formatted audit data generated by the transform application may be stored to a file, which may, for example, be utilized by an application program, such as a spreadsheet program, web browser, event analysis application, or other application.

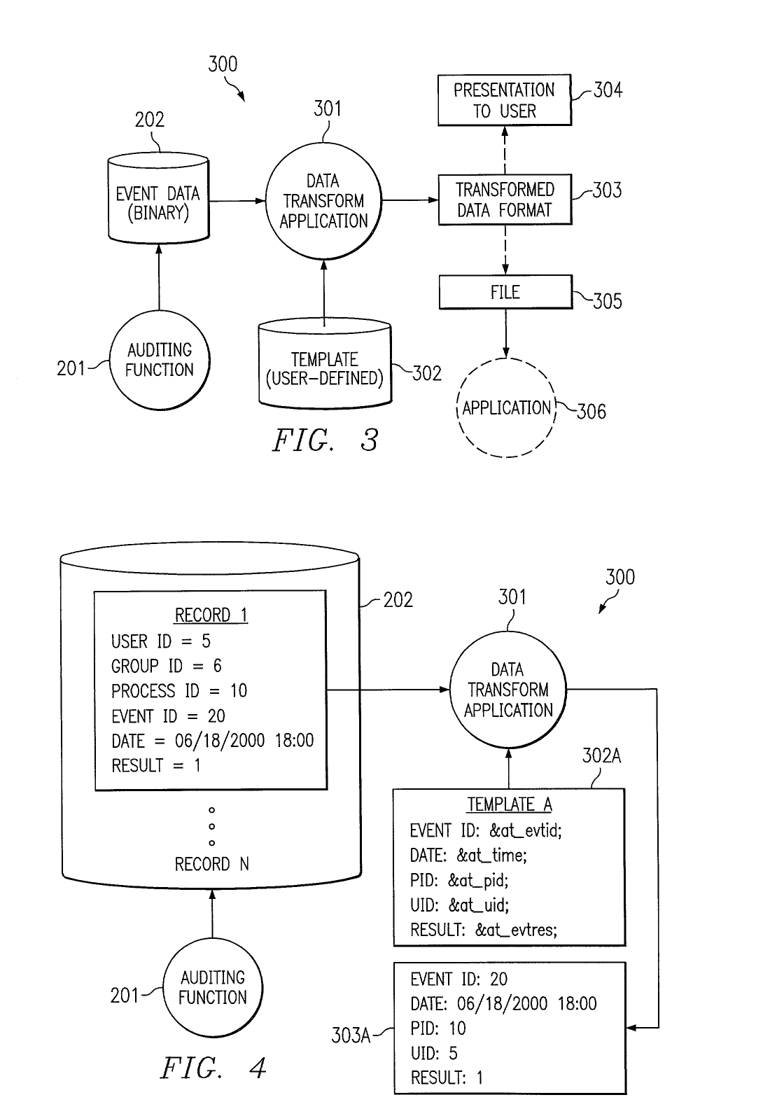

Turning to FIG. 3, an exemplary system 300 of an embodiment of the present invention is shown. System 300 may be any processor-based system having an OS executing thereon, including without limitation a personal computer (PC), laptop, and personal digital assistant (PDA). System 300 includes any suitable processor now known or later developed, including without limitation any processor from the Itanium™ family of processors, such as the McKinley processor, available from Hewlett-Packard Company, PA-8500 processor also available from Hewlett-Packard Company, and Pentium® 4 processor available from Intel Corporation. System 300 may further include input/output devices communicatively coupled thereto, including without limitation keyboard, pointing device (e.g., mouse, trackball, stylus, etcetera), display, and speakers, and may also include printer, facsimile, optical scanner, and other peripheral devices (which may be external devices communicatively coupled to processor-based system 300 or may be integrated within processor-based system 300). System 300 also includes an OS executing thereon, which may be any suitable OS now known or later developed, including without limitation HP-UX®, Linux™, Unix™, MS-DOS®, OS/2®, Windows® (e.g., Windows 2000®), System 8, MPE/iX, Windows CE®, and Palm™. According to at least one embodiment, such OS is a trusted OS, which provides security that limits the exposure of applications and resources of system 300 to potential attackers and/or mitigates attacks. Such a trusted OS may include kernel-enforced containment mechanisms and/or other security mechanisms.

The OS executing on system 300 includes auditing program 201, which provides auditing functionality, such as described above in conjunction with FIG. 2. More specifically, auditing program 201 audits use of routines (or “events”). In a preferred embodiment, such routines are OS routines utilized/invoked by applications and/or users, while in alternative embodiments such routines may comprise any application or system routines that may occur within a processor-based system. For instance, in a preferred embodiment, auditing program 201 may collect audit data regarding use of an OS routine that is invoked via a system call (or “syscall”) made by an application, and/or auditing program 201 may collect audit data for an OS routine that is invoked via user command. As described above, auditing program 201 may execute at the kernel level and may comprise an audit device driver. Additionally, auditing program 201 may also comprise an interface (e.g., API) from the kernel to user-space applications, which may enable event data to be passed to such user-space applications (e.g., an audit collection daemon) and/or may enable event data to be received at the kernel from user-space applications and/or users (e.g., system administrators). Thus, according to at least one implementation, program 201 may collect kernel audit events and application audit events received from user-space applications, as well as any other types of audit events desired to be collected by the OS. Alternatively, auditing program 201 may comprise an application executing in the user space of an OS to collect audit data relating to the execution of routines.

Once collected by auditing program 201, audit data (or “event data”) is stored to data storage 202. More specifically, an audit collection daemon may collect the audit data from the kernel (e.g., from an audit device driver) and store such audit data to data storage 202. Further, in at least one embodiment, collected audit data may be buffered within the kernel of the OS, and periodically collected for storage in data storage 202 by audit collection daemon. Also, if the kernel-level buffer begins filling, the kernel may notify the audit collection daemon, which then collects the audit data from the kernel and writes it to data storage 202. Additionally, in those implementations in which auditing program 201 executes in user space, audit data collected thereby may likewise be stored to data storage 202. Data storage 202 generally comprises a disk drive, but such data storage 202 may include any suitable data storage mechanism now known or later discovered including without limitation random access memory (RAM), floppy disk, optical disc (e.g., Compact Disc (CD) and Digital Versatile Disc (DVD)), and other data storage devices. Typically, collected audit data is stored in binary format within data storage 202. Audit data collected for a particular event (e.g., particular invocation of an OS routine) is generally referred to as a record. Thus, data storage 202 may include many records, wherein each record includes audit data for a particular event. According to at least one embodiment auditing is performed in a manner as further disclosed in concurrently filed and commonly assigned U.S. patent application Ser. No. ______ entitled “SYSTEM AND METHOD FOR AUDITING SYSTEM CALL EVENTS WITH SYSTEM CALL WRAPPERS,” the disclosure of which has been incorporated herein by reference.

According to at least one embodiment of the present invention, data transform application 301 is provided, which is executable to utilize template 302 to format audit data collected within data storage 202 to generate a desired (or transformed) data format 303, which may be referred to herein as output 303. As used herein, “template” is intended to broadly encompass any type of formatting model, which may be utilized by transform application 301 as a guide for generating desired audit data format 303. According to various embodiments of the present invention, template 302 may be user-defined, which may enable a user to effectively dictate the resulting format 303 generated by transform application 301. The resulting audit data having the desired format (output) 303 may be presented to a user, e.g., via a display and/or printer, which is shown as presentation 304 in FIG. 3. Alternatively or additionally, the resulting audit data having the desired format (output) 303 may be stored to file 305, which may be utilized by application 306. For example, output 303 may provide audit data formatted in a comma separated value (CSV) format (as dictated by template 302), and application 306 may be a spreadsheet application capable of receiving and displaying the audit data. As another example, output 303 may provide audit data in HTML, XML, or other markup language format (as dictated by template 302), and application 306 may be a web browser capable of receiving and displaying the audit data. Further, in certain implementations, output 303 may be generated for use within application 301, and therefore such output 303 may not be output external to application 301 but may instead be output generated within application 301 and utilized therein.

Data transform application 201 may be a special-purpose application provided by the provider of the OS for transforming audit data to a desired format as dictated by a user-defined template. Alternatively or additionally, data transform application 201 may comprise any application, which may utilize an application program interface (API), which may be referred to as an audit transformation API, to transform collected audit data to a desired format as dictated by a template according to at least one embodiment of the present invention. Thus, data transform application 201 may include an application developed by the user (e.g., system administrator) or an application developed by a third-party vendor, which utilizes the audit transformation API of an embodiment of the present invention. Of course, data transform application 201 may provide further functionality in addition to transforming audit data to a desired format in accordance with a template.

Thus, according to at least one embodiment of the present invention an audit transformation API is provided, which may be utilized by any application 201 to transform collected audit data to a desired format in accordance with a template. More specifically, according to at least one embodiment, the API provides functionality for reading collected (raw) audit data from data storage 202 and format such audit data into any desired representation (as defined by a template). The audit transformation API library of one embodiment includes various functions that may be utilized within an application, examples of which are described in greater detail hereafter.

One function that may be included within the API library is a function that enables a context to be created that specifies the desired audit data format to be generated. More specifically, such a function may enable a specified template, which may be specified by user input or in any other manner (e.g., via a specified input file), to be accessed, as well as a particular audit data file, which may also be specified by user input or in any other manner (e.g., via a specified input file). For example, an ata_open( ) function may be provided, which may be the first function called by an application utilizing the audit transformation API. Such ata_open( ) function may create a context by reading in a template (which may be referred to as an audit transformation template) and opening the desired audit event log file. An exemplary code portion utilizing such ata_open( ) function is as follows (with comments provided in asterisks, i.e., ***comments***):

int status; ***defines status variable as an integer***

char *logfile=“var/audit/log/2001-02-07.log”; ***defines logfile variable as a character and utilizes such logfile variable to indicate a particular audit event log file***

ata_context_t context; * **defines a context variable for operating the audit data. For example, additional information may be tracked when working with audit data, which may be stored in the context variable in a manner that is transparent to the user. The context may be used by the auditing routines, and the context may also contain the rules specifying how the audit data is to be presented/formatted* * *

status=ata_open(&context, logfile); ***the ata_open( ) function is called with &context and logfile, which specifies a desired audit event log file to be utilized***

Another function that may be included within the API library of one embodiment is a function that enables retrieval of the next record of the collected audit data. For example, an ata_next_event( ) function may be provided, which may get the next audit event record in the current audit event context being processed by an application (e.g., as such context is specified by the above-described ata_open( ) function). An exemplary code portion utilizing such ata_next event( ) function is as follows (with comments again provided in asterisks, i.e., ***comments***):

int status; ***defines status variable as an integer***

ata_context_t context; ***defines a context variable******

ata_event_t event; ***defines the audit event. That is, the audit data (audit record) or “event” is read from disk and stored in the event structure so that it can be more easily manipulated by the program***

. . .

while {(status=ata_next_event(context, &event)==0){

}***the ata_next_event( ) function is called with context and &event within a while loop to step through each record of the audit event log file (until status no longer equals 0, which indicates no further records are available)***

Another function that may be included within the API library of one embodiment is a function that formats a particular audit event record in the current audit event context (e.g., as such context is specified by the above-described ata_open( ) function). That is, such function executes to format a given record within the audit event log file (such record may be specified utilizing the above-described ata_next_event( ) function, for example) according to a context as defined by an audit transformation template. For example, an ata_format_event( ) function may be provided, which may format the given audit event record in the current audit event context. An exemplary code portion utilizing such ata_format_event( ) function is as follows (with comments again provided in asterisks, i.e., ***comments***):

int bytes; ***defines bytes variable as an integer***

char *fmt_event;***defines fmt_event variable as character***

ata_context_t context; ***defines a context variable***

ata_event_t event; ***defines the audit event***

. . .

bytes =ata_format_event(context, event, &fmt_event);***the ata_format_event( ) function is called with context, event, and &fmt_event, which comprises the string of how the data should be formatted/presented. Thus, the ata_format_event( ) functions to format the event specified by the variable event in accordance with the context defined by variable context. * * *

write(STDOUT, event_fint, bytes); ***the resulting formatted audit event is written to standard out***

The above-described functions are examples of the functionality that may be included within an audit transformation API library of an embodiment of the present invention. As described above, such functions can be used to perform such tasks as creating a desired context to be used in generating audit data having a desired format, advancing to the next record (or next event) of an audit event log file, and formatting a record (or event) in accordance with the created context, thereby generating audit data having a desired format. It should be understood that the exemplary functions described above are intended only as examples, which render the disclosure enabling for many other functions that may be included within an audit transformation API library. Thus, in various embodiments of the present invention, any number of functions may be included within an audit transformation API library to enable various functions for use in generating audit data having a desired format as specified by an audit transformation template.

Turning to FIG. 4, an exemplary implementation of one embodiment of the present invention is further illustrated. As described above, system 300 includes an OS executing thereon, which includes auditing program 201 for providing auditing functionality for auditing invocation of routines (or “events”), such as OS routines. As described above, auditing program 201 stores the audit data (or “event data”) to data storage 202. Audit data collected for a particular event (e.g., particular invocation of an OS routine) is generally referred to as a record. Thus, data storage 202 may include many records, wherein each record includes audit data for a particular event. For instance, in the example of FIG. 4 any number of records (1 through N) may be stored within data storage 202. Each record may comprise audit information relating to a particular event, as collected by auditing program 201. In the example of FIG. 4, record 1 includes such audit data as user ID (identification), group ID, process ID, event ID, date, and result for a particular event. Of course, for a particular type of event, auditing program 201 may be implemented to collect additional or different audit data than that shown in record 1 in the example of FIG. 4.

User ID may indicate the particular user that invoked the particular event (or to which the particular event relates), and in exemplary record 1 user ID has been assigned value 5 by auditing program 201, which indicates that a particular user identified by value 5 invoked the particular event. According to at least one embodiment, users may be assigned to groups. Group ID may indicate the particular group to which the user belongs, and in exemplary record 1 group ID has been assigned value 6 by auditing program 201, which indicates that the user identified by value 5 belongs to a group identified by value 6. Process ID may indicate the particular process that invoked the event (or to which the particular event relates), e.g., may identify the particular process that executed the syscall command. In exemplary record 1 process ID has been assigned value 10 by auditing program 201, which is a value that identifies the process (or program) that invoked the event (e.g., each process or program may be assigned an identifying value upon such process or program starting). Event ID may indicate the type of event that was invoked (e.g., file open, file close, etcetera), and in exemplary record 1 event ID has been assigned value 20 by auditing program 201, which indicates the syscall number identifying the type of event that was invoked. In the example of FIG. 4, “date” may indicate the date and time that the particular event (identified by event ID=20) occurred, and in exemplary record 1 date has been assigned value “06/18/2000 18:00” by auditing program 201, which indicates that the particular event of record 1 occurred Jun. 18, 2000 at 6:00 P.M. Also in the example of FIG. 4, “result” may indicate the result of the particular event (identified by event ID=20), such as success or failure of the event, and in exemplary record 1 result has been assigned value “1” by auditing program 201, which may indicate that the particular event of record 1 was successful (e.g., a value of “0” may indicate that the particular event was unsuccessful).

In the example of FIG. 4, a user has defined (or created) template A (or template 302A), which defines the desired format for the collected audit data. According to at least one embodiment of the present invention, data transform application 301 is provided, which is executable to utilize template A to format audit data collected within data storage 202 to generate a desired (or transformed) data format 303A. As shown in the example of FIG. 4, template A includes constant elements (e.g., textual elements defined by the user) and also includes variable elements, which may be referred to herein as “drop points,” that specify certain type of audit data. In the examples provided herein, drop points are indicated as a series of characters between “&” and “;”. For instance, “Event ID:” is a constant element defined by a user within template A, which is presented verbatim (as “Event ID:”) in the transformed data format 303A. Further, “&at_evtid;” is a variable element (or drop point), which specifies that the event ID type (or portion) of the collected audit data is to be included in place thereof, and accordingly, the value “20” is presented in place of the “&at_evtid;” drop point in the transformed data format 303A, as 20 is the corresponding value of the event ID of record 1 in the example of FIG. 4.

Thus, according to various embodiments of the present invention, constant elements may be defined by a user that are to be included verbatim in the generated output, and such constant elements may be used to provide a description of the data included in the output, for example. For instance, as described above, “Event ID:” may be a constant element included in a template that describes the data arranged thereafter in the resulting output 303A as being Event ID data. Further, variable elements may be included within templates to identify locations within the resulting format at which particular type of audit data is to be provided. For instance, as described above, variable element “&at_evtid;” may be utilized within a template, and such variable element identifies/represents a particular portion of audit data to be included in place of such variable element in the resulting output 303A. According to one embodiment of the present invention, as audit data is collected it is tagged with a tag that identifies its type of audit data. More specifically, as each portion of the audit data is collected that forms a record for an event, each portion is tagged to identify the type of information about the event that such portion provides, e.g., whether the portion of audit data provides Event ID information, User ID information, etcetera. Thus, the collected audit data of a record for an event may be stored within data storage 202 as shown in table 1 below. That is, table 1 provides an exemplary arrangement of a portion of record 1 of FIG. 4.

TABLE 1

| Tag | Data | Tag | Data | Tag | Data |
|---|---|---|---|---|---|
| ID_Event | 20 | IP_Process | 10 | ID_User | 5 |

Accordingly, data transform application 301 may access template A, which defines the desired output format, and may equate each variable element included in such template with a corresponding data tag in record 1. For instance, data transform application 301 equates drop point “&at_evtid;” with data tag ID_Event. Therefore, in generating the resulting output for drop point “&at_evtid;”, data transform application 301 finds data tag ID_Event within audit event record 1 and provides the corresponding data (i.e., 20 in this example) in place of drop point “&at_evtid;”.

Other exemplary variable elements included within template A of FIG. 4 are “&at_time;” (identifying the date value of the audit data), “&at_pid;” (identifying the process ID value of the audit data), “&at_pid;” (identifying the user ID value of the audit data), and “&at_evtres;” (identifying the result value of the audit data), for which the corresponding audit data values from record 1 are included in the generated data format 303A. That is, drop point “&at_time;” of template A is replaced with audit data value “06/18/2000 18:00” (the corresponding date value of record 1) in generated data format 303A, drop point “&at_pid;” of template A is replaced with audit data value “10” (the corresponding process ID value of record 1) in generated data format 303A, drop point “&at_uid;” of template A is replaced with audit data value “5” (the corresponding user ID value of record 1) in generated data format 303A, and drop point “&at_evtres;” of template A is replaced with audit data value “1” (the corresponding result value of record 1) in generated data format 303A. Also, further constant elements included within template A are “Date:”, “PID:”, “UID:”, and “Result:”, which appear in the resulting generated format 303A.

In the example of FIG. 4, data transform application 301 executes to generate output 303A that is formatted according to template A. As shown, output 303A includes audit data from record 1 formatted according to template A. Of course, data transform application 301 may be implemented to generate output that provides any record (e.g., a record other than record 1) and/or such output may include any number of records. For example, data transform 301 may utilize such commands described above as ata_next_event( ) and ata_format_event( ), as well as traditional programming commands (e.g., while loop commands, conditional statements, such as “if” statements, etcetera) to generate output 303A comprising any desired record(s) formatted according to template A. For instance, data transform application may comprise a while loop that steps through every record within a particular audit log file and outputs audit data from each record in the format defined by template A.

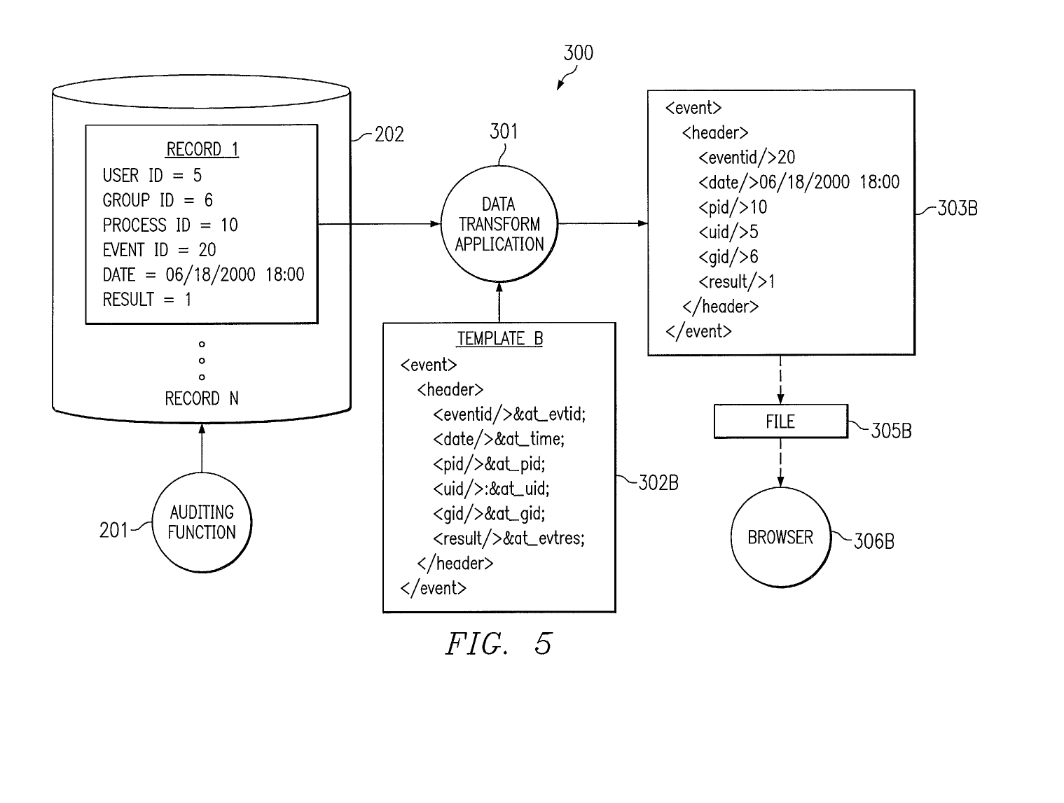

Turning to FIG. 5, another exemplary implementation of one embodiment of the present invention is illustrated. As described above, system 300 includes an OS executing thereon, which includes auditing program 201 for providing auditing functionality for auditing invocation of routines (or “events”). As also described above, auditing program 201 stores the audit data (or “event data”) to data storage 202. Audit data collected for a particular event (e.g., particular invocation of an OS routine) is generally referred to as a record. Thus, data storage 202 may include many records, wherein each record includes audit data for a particular event. Record 1, which is described above in conjunction with FIG. 4, is also shown in the example of FIG. 5.

In the example of FIG. 5, a user has defined (or created) template B (or template 302B), which defines the desired format for the collected audit data. More specifically, template B defines an XML format in which the collected data may be generated by data transform application 301. That is, data transform application 301 is executable to utilize template B to format audit data collected within data storage 202 to generate a desired (or transformed) data format 303B, which in this example is an XML format (as defined by template B). As shown in the example of FIG. 5, template B includes constant elements (e.g., textual elements defined by the user) and also includes variable elements or “drop points,” which specify certain type of audit data to be included in place thereof in the generated data format 303B. For instance, “<event>”, “<header>”, and “<eventid/>” are constant elements defined by a user within template B, which are presented verbatim (as “<event>”, “<header>”, and “<eventid/>”, respectively) in the transformed data format 303B. Further, “&at_evtid;” is a variable element (or drop point), which specifies that the event ID type (or portion) of the collected audit data is to be included in place thereof, and accordingly, the value “20” is presented in place of the &at_evtid; drop point in the transformed data format 303B, as 20 is the corresponding value of the event ID of record 1 in the example of FIG. 5.

Other exemplary variable elements included within template B of FIG. 5 are “&at_time;” (identifying the date value of the audit data), “&at_pid;” (identifying the process ID value of the audit data), “&at_uid;” (identifying the user ID value of the audit data), “&at_gid;” (identifying the group ID value of the audit data), and “&at_evtres;” (identifying the result value of the audit data), for which the corresponding audit data values from record 1 are included in the generated data format 303B. Also, further constant elements are included in template B, which appear in the resulting generated format 303B. Accordingly, the resulting data format 303B generated by data transform application 301 is an XML format that includes actual audit data values from data storage 202 in place of the corresponding drop points included in template B. As further shown in the example of FIG. 5, the generated XML format 303B may be written to file 305B, which may be processed by browser application 306B (e.g., to display a presentation as described by such XML file 305B in a manner commonly performed by browsers).

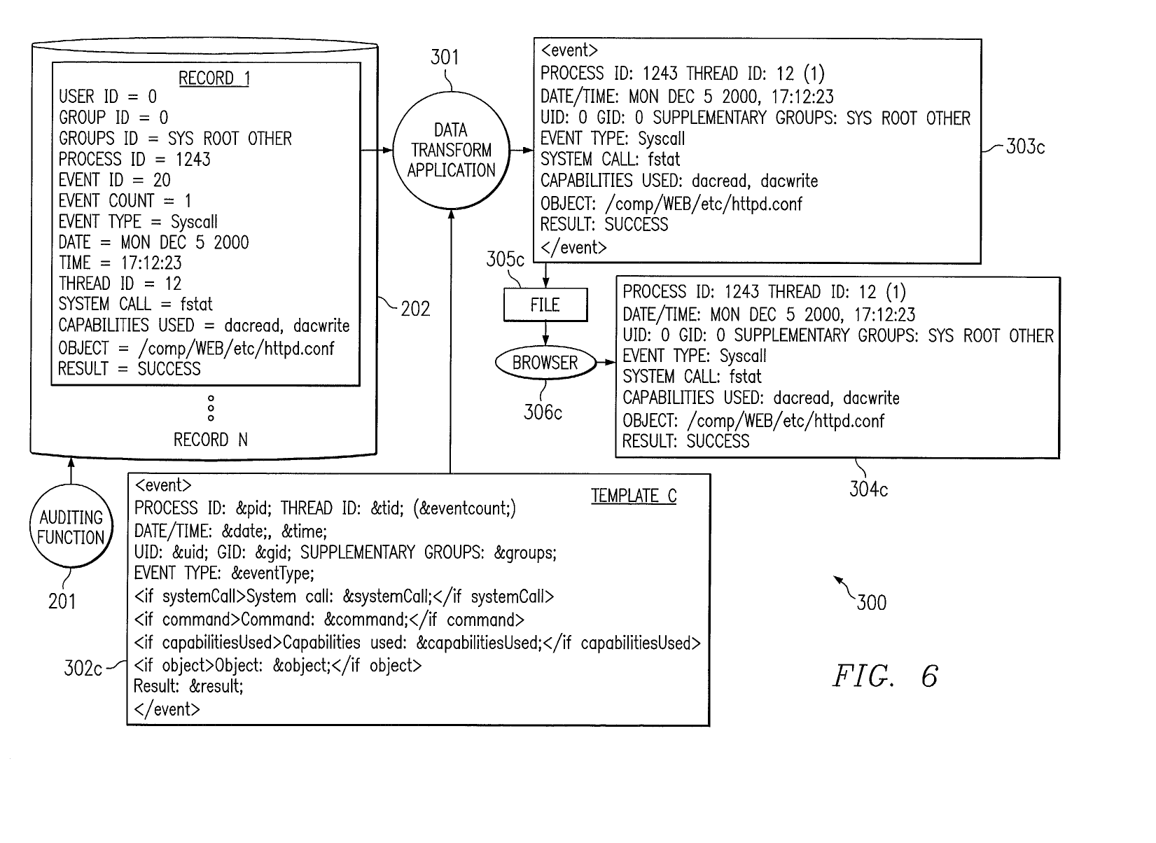

Turning to FIG. 6, yet another exemplary implementation of one embodiment of the present invention is illustrated. As described above, system 300 includes an OS executing thereon, which includes auditing program 201 for providing auditing functionality for auditing invocation of routines (or “events”). As also described above, auditing program 201 stores the audit data (or “event data”) to data storage 202. Audit data collected for a particular event (e.g., particular invocation of an OS routine) is generally referred to as a record. Thus, data storage 202 may include many records, wherein each record includes audit data for a particular event. Each record may comprise audit information relating to a particular event, as collected by auditing program 201. In the example of FIG. 6, record 1 includes such audit data as user ID (identification), group ID, process ID, event ID, and result for a particular event, which are described above in conjunction with FIG. 4. In this example, auditing program 201 is implemented to collect additional audit data to that shown in record 1 in the examples of FIGS. 4-5. For instance, record 1 further comprises such audit data as Groups ID (supplementary groups ID), event count, event type, date (which specifies the date of the occurrence of the particular event), time (which specifies the time of the occurrence of the particular event), thread ID, system call, capabilities used, and object.

According to at least one embodiment of the present invention, users may belong to more than one group (e.g., may have supplementary groups). Thus, supplementary groups ID may indicate the groups to which a user belongs, and in exemplary record 1 such groups ID has been assigned “sys root other” by auditing program 201, which indicates the groups to which the user belongs. In at least one embodiment, a sequential event counter may be utilized to associate a count with each record of an auditing session, which may enable a determination to be made as to the order in which the events occurred, for example. Thus, event count may indicate the sequential order in which an event occurred, and in exemplary record 1 event count has been assigned value 1 by auditing program 201, which indicates that this event was the first to occur in a particular auditing session. Event type may indicate whether the event is a syscall event or an application event, for example, and in exemplary record 1 event type has been assigned “syscall” by auditing program 201, which indicates that it is a syscall event. Thread ID may indicate the particular processing thread in which the event occurred, and in exemplary record 1 thread ID has been assigned value 12 by auditing program 201, which indicates that it occurred in the processing thread identified by value 12. In the example of FIG. 6, “system call” may indicate the specific system call that invoked the event, and in exemplary record 1 system call has been assigned “fstat” by auditing program 201, which indicates that the fstat system call invoked the event (e.g., to get the status of a file). Further, in the example of FIG. 6, “capabilities used” may indicate the privileges needed to invoke the syscall that invoked the event, and in exemplary record 1 capabilities used has been assigned “dacread, dacwrite” by auditing program 201, which indicates that such privileges were needed to invoke the syscall “fstat.” Object may indicate the subject of the operation, and in exemplary record 1 object has been assigned “/comp/WEB/etc/httpd.conf,” which indicates that the fstat syscall was performed on the file “/comp/WEB/etc/httpd.conf” to get the status of such file. Also in the example of FIG. 6, “result” may indicate the result of the particular event in textual form (e.g., “success” or “failure”), and in exemplary record 1 result has been assigned “success” by auditing program 201.

In the example of FIG. 6, a user has defined (or created) template C (or template 302B), which defines the desired format for the collected audit data. More specifically, template C defines a format that resembles VirtualVault Operating System (VVOS) “reduce” output. Data transform application 301 is executable to utilize template C to format audit data collected within data storage 202 to generate a desired (or transformed) data format 303C. As shown in the example of FIG. 6, template C includes constant elements (e.g., textual elements defined by the user) and also includes variable elements or “drop points,” which specify certain type of audit data to be included in place thereof in the generated data format 303C. For instance, “<event>”, “Process ID:”, and “Thread ID:” are constant elements defined by a user within template C, which are presented verbatim (as “<event>”, “Process ID:”, and “Thread ID:”, respectively) in the transformed data format 303C. Further, “&pid;” is a variable element (or drop point), which specifies that the process ID type (or portion) of the collected audit data is to be included in place thereof, and accordingly, the value “1243” is presented in place of the “&pid;” drop point in the transformed data format 303C, as 1243 is the corresponding value of the process ID of record 1 in the example of FIG. 6.

As further shown in the example of FIG. 6, according to at least one embodiment conditional elements may be included within an audit transformation template, such as template C. For example, the template syntax may allow for conditional drop point evaluation to be performed by data transform application 301. For example, a conditional element may be included within a template that may provide for differing event output formats depending upon the origin and context of the event data (e.g., application audit, syscall audit, network audit, etcetera), as examples. For instance, in the example of FIG. 6, template C includes the following conditional statement: <if systemCall>System call: &systemCall;</if systemCall>, which results in including “System call:” followed by the data identified by drop point &systemCall; to be included in generated output 303C if the record being accessed (e.g., record 1) is a system call record (or “syscall” record). Accordingly, in the example shown in FIG. 6, record 1 is determined (by data transform application 301) to be a system call record, and therefore the <if systemCall> condition of template C is satisfied, resulting in “System call: fstat” being included in the generated output 303C. Template C also includes the conditional statement: <if command>Command: &command;</if command>, which results in including “Command:” followed by the data identified by drop point &command; to be included in generated output 303C if the record being accessed (e.g., record 1) is a command record. Because record 1 is determined not to be a command record in the example of FIG. 6 (meaning that the <if command> condition is not satisfied), generated output 303C does not include the information specified by the conditional <if command> statement (i.e., does not include “Command:” followed by data identified by drop point &command;. Template C further includes other conditional statements: <if capabilities used> and <if object>, which result in the information specified in each conditional statement being included in the generated output 303C if the conditions are satisfied (e.g., if record 1 satisfies the conditional statement). Because both conditions are satisfied in the example of FIG. 6, generated output 303C includes the information specified by such conditional statements. As further shown in FIG. 6, the generated format 303C may be stored to file 305C, which may be processed by browser application 306C to generate presentation (or display) 304C.

As described above, some display applications 203 (FIG. 2) of the prior art may allow a user to effectively filter certain events (or certain records) for which audit data has been collected. For instance, display application 203 may enable a user to specify that all records collected during a particular time frame are to be presented, wherein the records outside of the particular time frame are filtered by display application 203 and not included in data presentation 204. While display application 203 of the prior art may allow a user to specify a filter of the records of audit data, such display application 203 generally does not allow a user to sort the records to be included in an output according to a particular field (or type of audit data) included within the records.

At least one embodiment of the present invention advantageously enables sorting of audit records (or events) that are to be included in an output based on a field (or type of audit data) included within the records. For instance, referring to FIG. 3, data transform application 301 may include code for utilizing template 302 to present audit information that is sorted according to a particular field of the records stored in data storage 202. For example, a while loop may be included within data transform application 301 that steps through the audit records in data storage 202 and determine a sorting of the records based on one or more fields of the records. As an example, the above-described ata_next_event( ) function may be utilized by the data transform application to step through the audit records. As data transform application 301 steps through the records it may analyze one or more fields of such records and determine a desired sorting of the records. The sorting desired may be input by a user or specified by a file, as examples. As an example, the audit records may be sorted based on type of event and date/time. For instance, all file open events may be sorted together and such file open events may be sorted based on date/time of their occurrence, and all file close events may be sorted together and such file close events may be sorted based on date/time of their occurrence, as examples. As the proper sorting of the records is determined by data transform application 301, it may utilize template 302 to generate output 303 that includes the audit data as sorted.

According to at least one embodiment of the present invention, a user (e.g., system administrator) may define one or more templates that generate desired data format(s) for collected audit data, and such desired data format(s) may be used for presentation (e.g., to a display or printer) and/or may be utilized to enable the collected audit data to be processed by one or more other applications (e.g., browsers, spreadsheets, system analysis applications, etcetera). Thus, for instance, while three exemplary templates are shown in FIGS. 4-6 and described in conjunction therewith, many other templates may be utilized to define any desired format for collected audit data. As other examples, the output format generated by transform data application 301 may be any markup language format, a suitable format for use in an event correlation engine for intrusion detection, any format desired for a text file, or a comma separated value (CSV) format (which may be an appropriate format to enable the audit data to serve as input data to a spreadsheet application, for instance). Various embodiments of the present invention provide an audit transformation API that enhances usability of collected audit data by enabling such audit data to be generated in any desired format in accordance with a template. Accordingly, functions provided by the audit transformation API may be utilized by any application to generate audit data in any desired format, as specified by an audit transformation template. According to at least one embodiment, the audit transformation template may be a user-defined template that is utilized to enable the API to read raw (e.g., binary) audit data and format it into any desired representation (or format), such as comma separated lists, XML, HTML, plain text, etcetera, as specified by such template.

What is claimed is:

1. A system comprising:
operating system providing at least one routine capable of being invoked, and said operating system operable to collect audit data for invoked operating system routines;
data storage having collected audit data stored thereto in a first format; and
software code executable by at least one processor to receive said collected audit data and generate output comprising at least a portion of said collected audit data in a desired format defined by a template, wherein said desired format is different than said first format.

2. The system of claim 1 wherein said template comprises at least one constant element.

3. The system of claim 2 wherein said at least one constant element is included verbatim in said output.

4. The system of claim 1 wherein said template comprises at least one variable element.

5. The system of claim 4 wherein said at least one variable element identifies a particular portion of the collected audit data to be included in said output.

6. The system of claim 5 wherein said at least one variable element identifies a location within said output at which said particular portion of the collected audit data is to be arranged.

7. The system of claim 1 wherein said collected audit data comprises a record for each invocation of an operating system routine that is included within said collected audit data, and wherein each record includes at least one type of audit information relating to execution of an invoked operating system routine.

8. The system of claim 7 wherein said at least one type of audit information includes at least one type selected from the group consisting of:
user identification, group identification, supplementary group identification, process identification, event identification, event count, event type, date, time, thread identification, system call, capabilities used, object, and result.

9. The system of claim 7 wherein said template comprises at least one variable element that each identifies a particular type of audit information to be included in said output.

10. The system of claim 1 wherein said template comprises at least one conditional element.

11. The system of claim 10 wherein said at least one conditional element dictates that said output is to have a particular format if a condition is satisfied, otherwise said output is to have a different format.

12. The system of claim 1 wherein said template defines a format selected from the group consisting of:
plain text, markup language, and comma separated format.

13. The system of claim 1 wherein said operating system comprises a kernel-level audit device driver for collecting said audit data.

14. A computer program product for generating audit data in a desired format, said audit data relating to execution of a routine, said computer program product comprising a computer-readable storage medium having computer-readable program code embodied in said medium, said computer readable program code comprising:
code executable to access audit data stored in a data storage device, wherein said audit data comprises information relating to execution of at least one invoked routine;
code executable to access an audit transformation template; and
code executable to generate output comprising at least a portion of said collected audit data, said output having a format defined by said audit transformation template.

15. The computer program product of claim 14 wherein said audit data is collected by an operating system.

16. The computer program product of claim 14 wherein said at least one routine includes at least one invoked operating system routine.

17. The computer program product of claim 16 wherein said at least one invoked operating system routine is invoked by an application via system call.

18. The computer program product of claim 16 wherein said at least one invoked operating system routine is invoked via user command.

19. The computer program product of claim 14 wherein said audit transformation template comprises at least one constant element that is included verbatim in said output.

20. The computer program product of claim 14 wherein said template comprises at least one variable elements.

21. The computer program product of claim 20 wherein said collected audit data comprises a record for each invocation of an operating system routine that is included within said collected audit data, and wherein each record includes at least one type of audit information relating to execution of an invoked operating system routine.

22. The computer program product of claim 21 wherein said at least one type of audit information includes at least one type selected from the group consisting of:
user identification, group identification, supplementary group identification, process identification, event identification, event count, event type, date, time, thread identification, system call, capabilities used, object, and result.

23. The computer program product of claim 22 wherein said audit data comprises multiple ones of said record, further comprising:
code executable to sort at least a portion of the multiple records based on at least one of said types of audit information.

24. The computer program product of claim 21 wherein said at least one variable element each identify a particular type of audit information to be included in said output.

25. The computer program product of claim 14 wherein said template comprises at least one conditional element, and wherein said conditional element dictates that said output is to have a first format if a condition is satisfied and have a different format if said condition is not satisfied.

26. A method of generating an output that includes collected audit data therein and has a desired format, said method comprising the steps of:
collecting audit data relating to the execution of one or more invoked routines;
storing said collected audit data to a data storage device;
accessing said collected audit data;
accessing an audit transformation template that defines a desired format; and
generating an output that includes at least a portion of said collected audit data, wherein said output comprises said desired format as defined by said audit transformation template.

27. The method of claim 26 wherein said audit data comprises information about at least one invoked operating system routine.

28. The method of claim 26 further comprising the step of:
creating, by a user, said audit transformation template.

29. The method of claim 26 wherein said audit transformation template comprises at least one constant element that is included verbatim in said output.

30. The method of claim 26 wherein said audit transformation template comprises at least one variable element.

31. The method of claim 30 wherein said at least one variable element identifies a particular type of audit information from said collected audit data to be included in said output.

32. The method of claim 31 wherein said particular type of audit information includes at least one type selected from the group consisting of:
user identification, group identification, supplementary group identification, process identification, event identification, event count, event type, date, time, thread identification, system call, capabilities used, object, and result.

33. The method of claim 26 further comprising the step of:
presenting said output to a user.

34. The method of claim 26 further comprising the step of:
storing said output to a file.

35. The method of claim 26 further comprising the step of:
inputting said output to an application for processing by said application.

36. The method of claim 26 further comprising the step of:
sorting said collected audit data based at least in part on at least one type of audit information included therein.

37. A library of software functions comprising:
function executable to access collected audit data, wherein said audit data comprises information about at least one invoked routine of said operating system;
function executable to access a template defining an output format; and
function executable to generate output comprising at least a portion of said collected audit data, wherein said output has a format defined by said template.

38. The library of claim 37 wherein said function executable to access collected audit data, said function executable to access a template, and said function executable to generate output are distinct functions.

39. The library of claim 37 wherein said function executable to access collected audit data, said function executable to access a template, and said function executable to generate output are included within a common function.
